(19) United States
(12) Patent Application Publication
(10) Pub. No.: US 2017/0315341 A1
(43) Pub. Date: Nov. 2, 2017

(54) Continuous-Scanning Image Acquisition In Automated Microscopy Using Reflective Autofocus

(71) Applicant: Vala Sciences, Inc., San Diego, CA (US)

(72) Inventors: Derek N. Fuller, San Diego, CA (US); Behrad Azimi, San Diego, CA (US); Gregory G. Gemmen, San Diego, CA (US)

(73) Assignee: Vala Sciences, Inc., San Diego, CA (US)

(21) Appl. No.: 15/653,920

(22) Filed: Jul. 19, 2017

Related U.S. Application Data
(63) Continuation of application No. 13/714,292, filed on Dec. 13, 2012, now abandoned.

(51) Int. Cl. G02B 21/36; G02B 21/24

(52) U.S. Cl. CPC G02B 21/361; G02B 21/244; G02B 21/365

(57) ABSTRACT

Continuous-scanning image acquisition in an automated microscopy system uses an image reflected off of an object that supports a specimen being imaged to automatically focus the microscopy system.

### BACKGROUND

The field is automated cytometry. More particularly, the field is related to an automated microscope equipped for continuous-motion scanning to acquire images of biological specimens in which focus is automatically maintained using reflection from a moving object supporting a biological specimen.

As used in automated microscopy systems performing high content screening, continuous scanning overcomes the speed limitations of traditional sequential scanners, in which the repeated acceleration and deceleration of a relatively massive microscope stage to sequentially image many adjacent fields of view fundamentally limits speed. An example of an imaging system used in automated microscopy to accomplish continuous scanning employs a time-delay and-integration (TDI) camera. In this regard, see M. E. Bravo, et al., “Dynamic autofocus for continuous-scanning time-delay-and-integration image acquisition in automated microscopy,” J. Biomed. Optics 12(3), 034011 (May/June 2007).

Bravo et al. taught that image quality is maintained during the continuous scanning process based upon contrast of magnified images of biological specimens acquired by the automated microscopy system as scanning progresses. In this regard, a plurality of specimen images is acquired at axially-spaced focal planes and the focus of the microscope is changed to the focal plane with the highest contrast by adjusting the axial distance between the objective lens. In this regard, see also U.S. Pat. Nos. 5,548,661; 5,790,710; 5,790,710; 5.995,143; 6,640,014; and 6,839,469.

Previous automated microscopy systems that combine image-based autofocus with continuous scanning are known for increasing the throughput of high content screening. The system reported in H. Netten, et al., (“A fast scanner for fluorescence microscopy using a 2-D CCD and time delayed integration □image cytometry□.” Bioimaging 2; 4, pp. 184-192, December 1984) followed a prerecorded focus path during continuous scanning, as does the Aperio Technologies (Vista, Calif.) brightfield and fluorescence system for scanning tissue sections. The system by K. R. Castleman (“The PSI automatic metaphase finder,” J. Radiat. Res. 33; Suppt: 124-8; March 1992) apparently paused to perform static autofocus at regular intervals, and those by Shippey et al. (“A fast interval processor (FIP) for cervical prescreening,” Anal Quant Cytol. 3(1), 9-16 Mar. 1981) and Tucker et al. (“Automated densitometry of cell populations in a continuous-motion imaging cell scanner,” Appl. Opt. 2(16), 3315-3324 (August 1987) autofocused dynamically during scanning. Both Shippey et al. and Netten et al. reported that the focus error was greater than the depth of field, and Tucker et al. reported that a 1 um focus error produced a 12% error in the integrated optical density of the cell nucleus. Autofocus accuracy was reported to be very dependent on the density of cells by Castleman, and the need for many cells in each field of view was common to all of the systems that included autofocus. None of these designs have been widely adopted. None achieved stage speeds larger than 4 mm/sec. Among other practical shortcomings, the techniques and problems reported with them point to large focus errors that would limit use in high-resolution microscopy, relatively few focus updates per image field due to the low-speed nature of autofocus used, and dependence on cell density for reliable focus tracking. The chief shortcoming of all these methods appear to be the use of content-based (or image-based) autofocus method which is slower partly due to its requirement for image acquisition and limits on signal brightness.

An example of the use of surface tracking and confocal imaging in high content screeners comes from the GE high content analysis imagers, which use reflective positioning off of the surface of the substrate for focusing a laser slit-illuminated partial confocal light beam that is scanned continuously. The partial confocal imaging corrects for medium resolution (NA 0.6) focus errors by removing some out-of-focus image information to perform optical sectioning, which makes it less critical to find the average best focus across the field. Similarly, the Evotec Opera™ (Woburn, Mass.) and the BD Pathway™ (Franklin Lakes, N.J.) systems use spinning disk confocal image acquisition to remove out-of-focus light. These confocal systems tend to be 2- to 3-fold more expensive than wide field fluorescence instruments. Moreover, they are often slow due to their inherent sequential scanning method and requirement to accelerate and decelerate from field to field.

In other methods where continuous scanning and surface tracking exist on the same system, they are never used simultaneously. One such method, described in U.S. Pat. No. 7,518,652 uses a reflected laser positioning system to measure focus positions of the specimen at different points prior to the start of the scan. The system then generates a best fit plane through the measured points which is used as a look up table to find best focus. Because of variation in specimen mounting and specimen thickness, this method can require many points to be selected by the user and therefore has limitations in terms of its throughput.

Another reflective focusing system adjusts microscope focus to compensate for axial drift by changing the axial distance between the objective lens and the stage of the microscope so as to obtain the best focus of an optical image reflected from a focal plane on a microscope slide on which a specimen is supported. A manually entered offset value is added to the axial distance so as to maintain the focal plane of the microscope within the specimen. See U.S. Pat. No. 7,071,451, for example. Reflective positioning has advantages of simplicity. However, reflective positioning systems are typically employed in incremental scanning, but are not used in continuous scanning applications.

In some aspects of continuous-motion scanning cytometry, an automated microscopy system may require an autofocus system that is inexpensive and simpler and easier to operate than prior art autofocus systems.

### SUMMARY

A system and method for continuous-scanning image acquisition in an automated microscopy system uses an image reflected off of a surface of an object that supports a specimen being imaged to automatically focus the microscopy system.

In some aspects, autofocus is maintained by a reflective positioning system for continuous-scanning time-delay-and-integration (TDI) image acquisition in an automated microscopy system.

In some aspects, the reflected image used for autofocus is obtained from a surface of an object supporting the specimen.

### BRIEF DESCRIPTION OF THE DRAWINGS

FIG. 1 is an optical schematic drawing of a time-delay-and-integration system (TDI) as used for continuous-scanning image acquisition in an automated microscopy system.

FIG. 2 is a schematic illustration of continuous-scanning image acquisition of a region of interest in a specimen of biological material.

FIG. 3 is a schematic drawings showing reflection of an optical spot used for automatic focus by a continuous-scanning image acquisition system.

FIG. 4 is a schematic illustration of an automated microscopy system that combines continuous scanning with surface tracking to obtain in-focus images of specimens mounted on a mounting substrate.

FIG. 5A is a flow diagram illustrating a method of continuous scanning image acquisition in an automated microscopy system that uses surface tracking to obtain in-focus images of specimens mounted on a medium.

FIG. 5B is a flow diagram illustrating image acquisition by an array of TDI cameras.

FIG. 6 is an enlarged view of a representative image strip acquired on a 384-well plate.

### DETAILED DESCRIPTION OF THE PREFERRED EMBODIMENTS

In this description, an automated microscopy system is equipped for continuous-scanning image acquisition using reflective autofocus. In this regard, continuous-scanning image acquisition can be implemented in a number ways, including, without limitation, time-delay-and-integration, line array charge-coupled-devices, or any equivalent thereof. Therefore, the use of any particular continuous-scanning implementation described herein is to be understood as being merely illustrative of continuous-scanning image acquisition.

The automated microscopy system scans specimens at very high throughputs by collecting images while the specimen is moving. In traditional microscopy applications, images are collected field by field while the specimen is moved to the field, stopped for image collection and then moved to the next field. The need to accelerate and decelerate the specimen can be responsible for a large portion of the scan time in this method. In continuous scanning, however, images are collected as the specimen moves at a constant speed, eliminating the need to accelerate and decelerate and hence increasing imaging throughput.

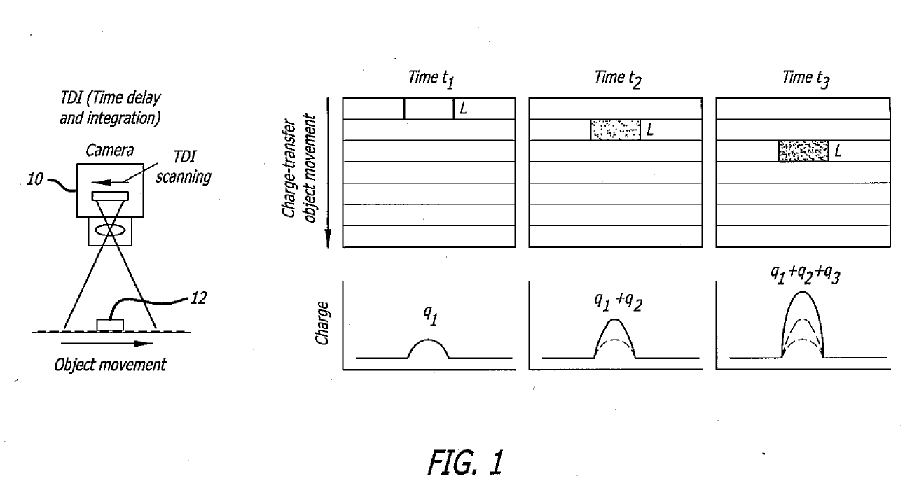

An illustrative example of continuous-scanning image acquisition is presented in FIG. 1, where a TDI camera 10 transfers charges from pixel to pixel in a scan direction synchronously with the image of a specimen 12 moving across the field of view of the camera's chip. Throughout the camera's transfer across a full row having a width of W pixels in a region of interest (ROI) in the specimen, the charges collected correspond to a single point on the specimen. The time it takes for the charges to transfer across the row, and meanwhile build up (q₁, q₁+q₂, q₁+q₂+q₃) is equivalent to exposure time in traditional sequential imaging. Synchrony between the charge transfer rates and the speed of the specimen is accomplished by setting the transfer rate (Internal Line Rate) on the camera to correspond with a given stage target velocity. Charges are collected and transferred across the W pixels while a longer direction covers a large area of the specimen in each sweep.

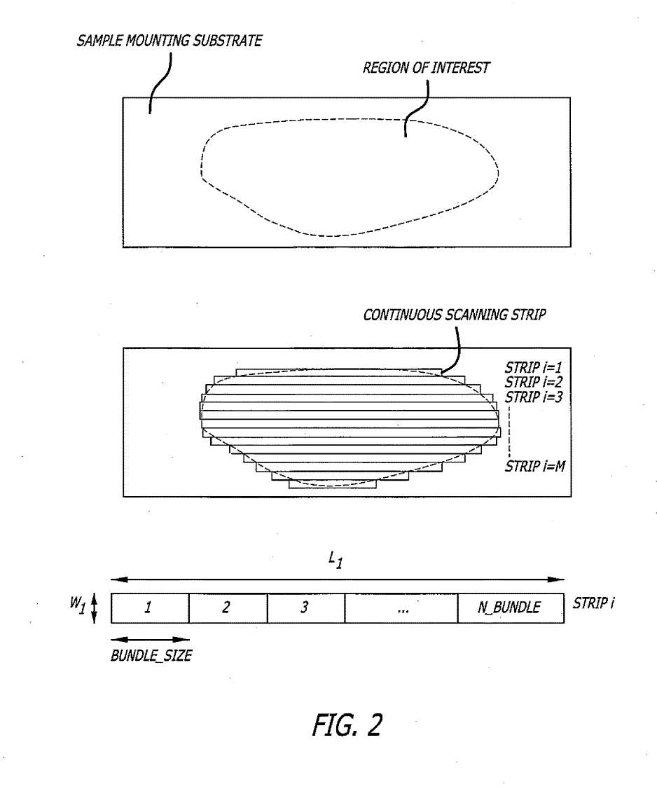

A complete scan consists of m strips that sufficiently cover the desired ROI to be scanned, as indicated in FIG. 2. In the present illustrative example, each strip is Wᵢ wide in number of pixels (equivalent to Wᵢ*PixeL_Size*Magnification in physical size on the specimen). These strips need not necessarily touch side-to-side. They can be separated by a particular distance as would be the case for scanning the rows of a well plate or even overlap to scan areas of the specimen more than once. Each strip is Lᵢ long (units of length) in physical specimen size, a distance that accounts for both the ramp up and ramp down of the XY Stage to attain its target velocity SCAN_VEL, from the start and to the end of the strip. The total distance that the acceleration (A) and deceleration represent is SCAN_VEL²/A, so that the total length of each strip Lᵢ≧Xᵢ+SCAN_VEL²/A, where Xᵢ is the distance of the i^{th} strip across the ROI in specimen space. Scanning longer than the minimal distance (i.e., the equality case in the L; expression) might be necessary to account for instrument lags.

In pixel space, each strip is Wᵢ wide and (Lᵢ*MAGNIFICATION/PIXEL_SIZE) long. As indicated in FIG. 2, this strip will be represented by a number (N_BUNDLES) of image data bundles, each BUNDLE_SIZE pixels long by W; pixels wide, depending on the onboard buffering and data transfer operation of the camera (i.e., a truly continuously streaming camera would have a BUNDLE_SIZE=1). Therefore, N_BUNDLES would be the minimal number of bundles to image sufficiently the i^{th} strip, and it is calculated by N_BUNDLES==┌{Lᵢ*MAGNIFICATION/(PIXEL_SIZE*BUNDLE_SIZE)}┐, where the brackets ┌ ┐ indicate rounding up to the nearest integer.

A linear pixel array can substitute the TDI camera and accomplish the continuous scanning. For the purposes of this description, the linear pixel array can be viewed of as a two dimensional array of pixels with the scan dimension having size one. In this case, transfers of charges are not necessary and the pixel data is read off at each image read-off interval.

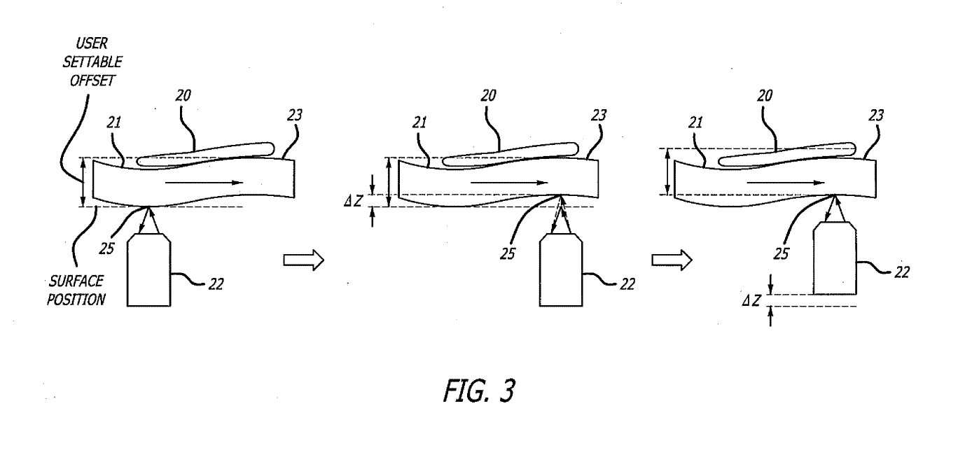

With reference to FIG. 3, the objects that biological specimens are mounted on (hereinafter, “mounting substrates”) are not always flat and often contain fluctuations which cause movement of a specimen along the optical axis of the objective lens through which images are acquired. Such movements cause out-of-focus images. In order to compensate for loss of focus due to such movements, a tracking method is implemented in an automated microscopy system equipped with continuous-scanning image acquisition to ensure that images collected are in good focus throughout the scan. In FIG. 3, a specimen 20 is mounted on a surface 21 of a mounting substrate 23 The tracking method utilizes a reflective positioning system that works by measuring the displacement (ΔZ) of the substrate along the optical axis (Z) and moving the objective lens 22 (and/or a stage on which the mounting substrate is carried) by the measured displacement distance to correct for variations in the position of the mounting substrate 23. In this method, the position of the specimen is measured by sensing, among other methods, the displacement of reflection of a laser spot 25 off of one or more surfaces of the mounting substrate. This displacement is then translated into physical Z position of the specimen. Focusing is done by adjusting the position of the objective, or the specimen, to ensure the distance between the objective and the specimen is closest to the working distance of the objective.

In order to allow users to image an arbitrary plane of interest away from the mounting substrate, an offset can be set in the tracking system. The offset effectively manipulates the target position of the tracking system so that the distance between the objective and the object of interest is close to the working distance of the objective (i.e., image in-focus at the image plane). Implementation of this offset can be enabled by physically moving the position sensor in the tracking system, by arbitrary addition of an offset to the measured position, by addition of optical components in the tracking or imaging light path, or by other methods.

An exemplary implementation of an automated microscopy system equipped for continuous-scanning image acquisition maintains focus by use of a reflective autofocus that tracks a surface, or a layer, or a lamina of the mounting substrate via a through-the-lens reflective positioning mechanism. For example, a Nikon® Ti Eclipse microscope equipped with a Perfect Focus (PF) system can be used as a base imaging platform. The PF system employs a laser light path through the objective lens to detect the position of the mounting substrate at any time. It then moves the objective lens to ensure it is always at its working distance from the imaging plane. An offset is employed to account for the distance between the surface, layer, or lamina being tracked (e.g., cover glass) and where biological specimen of interest resides.

In the case of the PF system, the measurement of displacement is accomplished by monitoring the reflection of a laser beam off of one of the surfaces (top or bottom, for example) of the mounting substrate as imaged on a linear CCD light detector. As the mounting surface moves up or down, the reflected image of the laser beam moves away from the center of the linear CCD. This displacement away from the center of the linear CCD is then used to calculate the approximate physical displacement of the mounting substrate. The objective or mounting substrate is then moved by the same amount to position the reflected image back to the center of the linear CCD.

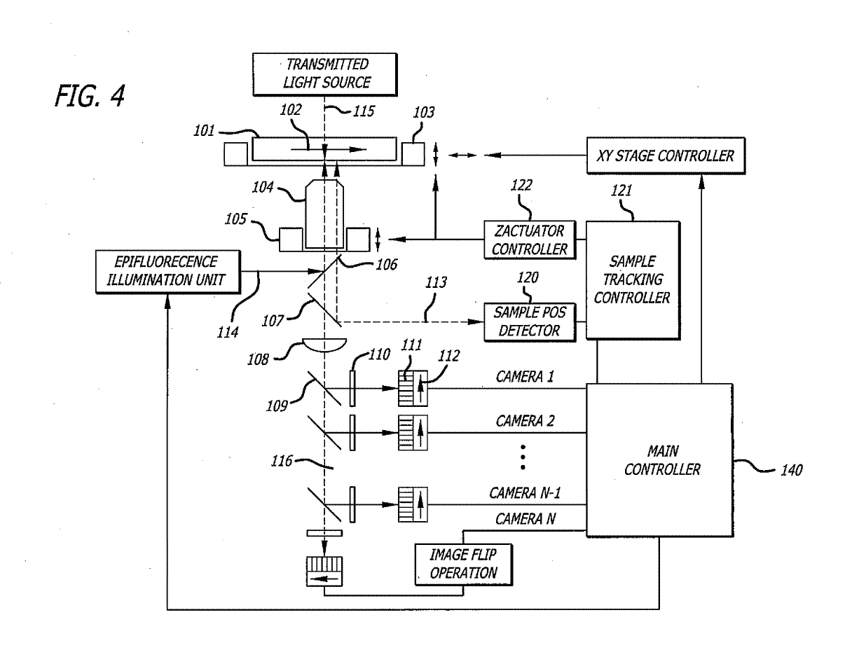

FIG. 4 illustrates an automated microscopy system that combines a continuous scanning unit with surface tracking unit to obtain in-focus images of specimens mounted on a mounting substrate. In this system, a mounting substrate 101 with a specimen mounted thereon is placed on an XY stage 103. Once a region of interest is identified, the mounting substrate 101 is moved in a direction 102 across a scanning axis. In epifluorescence applications, the excitation light path 114 is comprised of an epifluorescence illumination unit, condensor lenses and the excitation dichroic mirror 106 underneath the objective. In transmitted imaging application a transmitted light path 115 includes a transmitted light source and a condensor tower placed above the XY stage 103, in alignment with the optical axis. The specimen is imaged using an objective lens 104 and a tube lens 108 that forms an image plane.

The automated microscopy system includes a continuous-scanning image acquisition unit that operates according to the time-domain-and-integration principles illustrated in FIGS. 1 and 2. The continuous-scanning image acquisition unit is constituted of the XY stage 103, an XY stage controller, and one or more TDI cameras 111. Image acquisition can be split among multiple cameras 111 using appropriate dichroic mirrors 109 and emission filters 110. The multiple cameras 111 can be put on the same optical path by adding relay lenses to accommodate extended optical path of multi-camera systems.

Biological samples and the surfaces they are mounted to are not always flat and often contain fluctuations which cause out of focus images. In order to circumvent this, a sample tracking method according to FIG. 3 is implemented in the automated microscopy system of FIG. 4 that ensures images collected are in best focus throughout the scan. The automated microscopy system includes a surface tracking unit operating according to the reflective positioning principles illustrated in FIG. 3 to perform an autofocus function. The surface tracking unit operates continuously during scanning by measuring the displacement (AZ) of the mounting substrate and moving the objective lens (or the mounted specimen) by the measured displacement distance to correct for variations in the position of the mounting substrate. The surface tracking unit does this by tracking an optical image (such as a spot) reflected from a surface, layer, or lamina of the mounting substrate. In this regard, the surface tracking unit includes a closed-loop control mechanization constituted of a bidirectional optical path 113, a position detector 120, a tracking controller 121, and a Z actuator controller 122. The position detector 120 contains the optics (light source, lenses, beam splitter and linear light detector) that generate an optical spot that is reflected from a surface, layer, or lamina being tracked and that detect displacement of the reflection of the spot from that surface. The tracking controller 121 translates the displacement of the reflected spot into the physical Z position of the specimen. Based upon the current position, the Z actuator controller 122 outputs one or more positioning signals to an objective actuator 105 and/or the XY stage 103 to ensure that the distance between the objective and the specimen is constant. The commercially available Nikon® PF system includes elements that correspond to the tracking controller, the position detector, and the Z actuator controller.

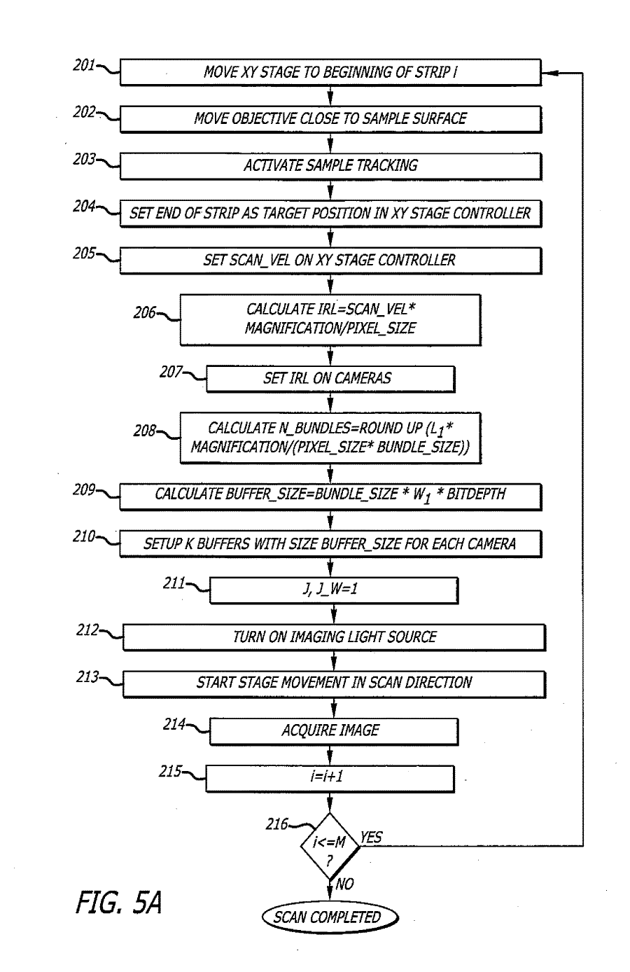

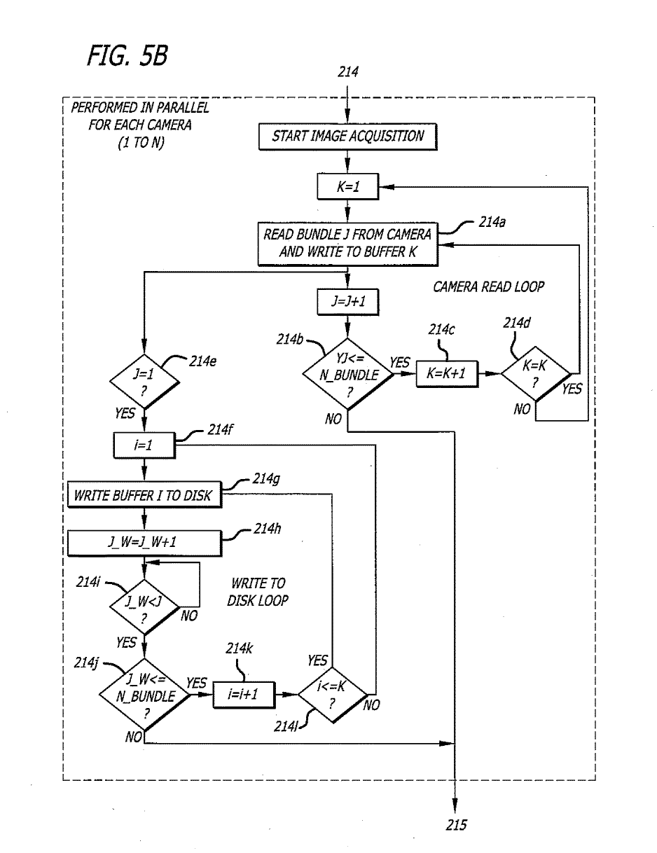

The process of scanning, illustrated in FIG. 5A, starts with loading scan parameters from a file or by determining them from user input. The parameters required to perform the scan are illustrated in Table 1.

TABLE 1
Parameters required to scan a region of interest.

| Parameter | Description |
|---|---|
| SCAN_VEL | User determined or calculated |
| | based on equivalent exposure time. |
| PIXEL_SIZE | Pixel size of the camera. |
| MAGNIFICATION | Effective magnification of the imaging |
| | system (objective and all relays). |
| m | Number of strips to be scanned. |
| Lᵢ (i = 1 . . . m) | Physical length of each strip along |
| | the scan direction. |
| Wᵢ(i = 1 . . . m) | Pixel width of each strip. |
| BUNDLE_SIZE | Number of lines read off of the |
| | camera at each read interval. |
| BITDEPTH | Bit depth of pixel data read from the camera. |

The scan process, as detailed in FIG. 5A is carried out by operation of the automated microscopy system of FIG. 4 in response to a control mechanization implemented by way of a set of instructions executed by the main controller 140 of the automated microscopy system as follows.

At 201 the XY-stage is positioned beginning of the i^{th} strip at a prescribed position in order to image the entirety of the i^{th} strip. This positioning includes any necessary motions orthogonal to the scan direction. At 202 the objective is moved to a prescribed z-position close to the surface representing a sufficient level of focus. At 203 the automatic tracking mechanism is activated, rendering the z control of the objective to the mechanism in order to keep the specimen sufficiently in focus optically. At 204 the end of the strip is set as the target position in the XY-stage controller in order to image the entire length Lᵢ of the i^{th} strip. At 205, the desired velocity, V, and acceleration in the XY-stage controller commensurate with the desired “exposure time” are set for the given experimental conditions; a faster velocity corresponds to a shorter exposure time, and vice-versa. At 206 the Internal Line Rate (IRL) is calculated to be utilized by the camera(s), determined by IRL=V*Magnification/Pixel_Size. At 207 the camera(s) are configured to acquire data at the calculated IRL. At 208 the needed number of data bundles, N_BUNDLES, is calculated each of a prescribed number of data lines, BUNDLE_SIZE, according to:

N_BUNDLES=┌{(Lᵢ*MAGNIFICATION/(PIXEL_SIZE*BUNDLE_SIZE)}┐

where the brackets ┌ ┐ indicate rounding up to the nearest integer. N_BUNDLES can not be fractional and needs to be sufficiently large to accommodate the image data of the entire i^{th} strip. This bundling is a necessary consequence of the internal buffering and data transfer mechanism of the camera(s); for camera(s) that continuously stream image data BUNDLE_SIZE=1, for example. At 209 the size of a buffer needed to accommodate one image data bundle is calculated according to:

BUFFER_SIZE=BUNDLE_SIZE*Wᵢ*BITDEPTH

where Wᵢ is the width (in pixels) of the image in the direction orthogonal to the scan direction and BITDEPTH is the number of bits the camera utilizes for representing the detected light intensity for each pixel. For convenience in data handling, the BITDEPTH might be rounded up to the nearest byte size (e.g., each pixel from a 12-bit camera might be handled “off the camera” as a 16-bit (two byte) data point). At 210 K buffers are allocated in memory, each with size BUFFER_SIZE. These K buffers form the “circular buffer” utilized in passing the data from camera to memory disk, and initialize a buffer loading counter for these buffers. k=1. At 211 two counters are initialized, one for the reading of the image data in BUNDLE_SIZE image line increments and one for writing the data to disk in BUFFER_SIZE increments. Those two counters are represented as J and J_W, respectively, so that both J=1 and J_W=1 initially. At 212 the imaging light source is turned on according to the prescribed experimental conditions. At 213 stage movement in the scan direction starts. At 214 image acquisition in the camera(s) starts. It should be noted that the initiation of the stage movement and the image acquisition could be coordinated with a hardware or software trigger and may include a prescribed lag from stage movement to image acquisition (or vice versa) to accommodate intrinsic hardware lags. At 215 the J^{th} image data bundle is read from the camera and written to the k^{th} buffer in memory (e.g., the first image data bundle (J=1) is written to the first buffer (k=1) in the “circular” buffer). At this point the CAMERA READ LOOP and the WRITE TO DISK LOOP illustrated in FIG. 5B diverge and run in parallel, so that the CAMERA READ LOOP always “stays in front” of the WRITE TO DISK LOOP.

With reference to FIG. 5B, the CAMERA READ LOOP runs at 214a after the J^{th} image data bundle is read from the camera, increment the reading counter. J is incremented to J+1. At 214b, if the number of bundles read J is greater than N_BUNDLE (i.e., there are no more image bundles to read in the i^{th} strip), the image acquisition for this strip is complete and the control program waits for the WRITE TO DISK LOOP to complete before incrementing the strip counter, (i.e., i=i+1) and moving on to the next strip. In this instance, skip 214c through 214d, as those steps represent continuing the image acquisition for the i^{th} strip. Otherwise, at 214c if J is equal to or less than N_BUNDLE (i.e., are there more images bundles to read), increment the buffer loading counter k=k+1, so that the next read image will be written to the next buffer in the circular buffer and not overwrite the previous buffer (i.e., the k^{th} buffer). Then, at 214d if the incremented buffer loading counter k (from 214c) is now less than or equal to the number of buffers K (i.e., the buffers in the “circular buffer” have not been cycled through completely; k<=K), read the next image data bundle J from the camera and write to the k^{th} buffer. If the incremented buffer loading counter k is now greater than K, reinitialize the buffer loading counter to k=1 so that the next read image bundle will be written to the first buffer in the “circular buffer” structure. This loop (214c and 214d) continues until all of the needed image bundles N_BUNDLE are read from the camera(s), with each image data bundle being read from the camera(s) and written to the next available buffer in the “circular buffer”, the counter for which (i.e., k) needs to be refreshed for every K image bundles read.

It is the responsibility of the WRITE TO DISK LOOP to write each buffer to disk in a coordinated fashion so that no image data is overwritten in any of the K buffers by new image data before it is written to disk. At 214e upon the reading of the first image bundle from the camera(s), a separate buffer unloading counter, l=1 is initialized. This buffer unloading counter functions in much the same way as the buffer loading counter k of steps 214c and 214d, but it controls which allocated memory buffer (and its image bundle data) is written to disk. At no time will the two counters k and l point to the same allocated memory buffer (of the K available), as the buffer unloading (i.e., the writing to disk) should always lag the buffer loading (i.e., the image acquisition). At 214g, the l^{th} buffer is written to disk. At 214h, the image bundles written counter is incremented J_W=J_W+1. At 214i, as writing the image bundles to disk must always lag the acquisition of the image bundles, a check is performed to confirm that J_W<J. If it is not, the WRITE TO DISK LOOP pauses (i.e., repeatedly check if J_W<J) until J exceeds J_W. At 214j, the loop checks the number of bundles written counter to determine whether J_W is less than or equal to the number of bundles in the strip, N_BUNDLE. If not (i.e., all N_BUNDLE image data bundles have been written), the WRITE TO DISK LOOP for the ith strip is complete and the strip counter i can be incremented (mentioned in step 214b). If there are still image bundles to write (J_W is less than or equal to N_BUNDLE), then the buffer unloading counter is incremented by l=l+1 at 214k. At 214l If the buffer unloading counter l is less than or equal to K (the number of allocated memory buffers), the l^{th} buffer is written to disk, appending the data to that which has already been written to disk. If the buffer unloading counter l is greater than K, write the buffer is written to disk and l=1 is reinitialized at 214f. The WRITE TO DISK LOOP is traversed until all N_BUNDLE image bundles are written to disk (i.e., J_W=N_BUNDLE), always lagging the acquisition of image bundles in the CAMERA READ LOOP.

Returning to FIG. 5A, when both the counters J>N_BUNDLE and J_W>N_BUNDLE, all of the bundles have been acquired and written, and the strip is done. At this point the strip counter i can be incremented i=i+1 at 215. The control loop then checks at 216 to see if all the strips have been scanned (i.e., i<=m, where m is number of strips to be scanned). If there are strips yet to be scanned, the process from step 201 is repeated in its entirety. If there are no more strips to be scanned, the scan as a whole is complete.

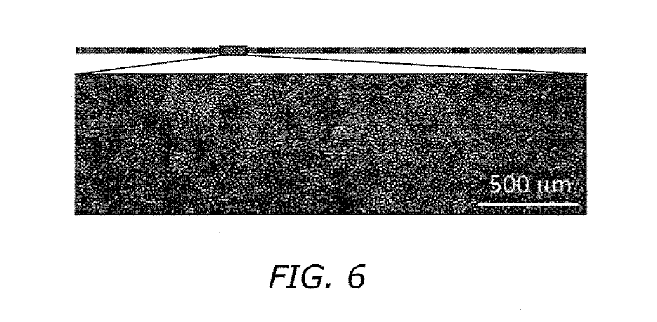

As a result of its fast surface tracking and continuous scanning method, an implementation of an automated cytometry system illustrated in FIGS. 4, 5A, and 5B collected images at specimens moving at a rate of 12 mm/sec with no apparent motion blur or loss of focus. With a 10× objective, this translates to 29.5 mm² of area scanned per second. This type of scan produces a 2048 pixel wide (2.458 mm wide on specimen for 10× magnification) strip that is collected in each scanning sweep. FIG. 6 illustrates a representative strip collected on a 384-well plate. To scan a full 66 mm×24 mm coverslip, the automated cytometry system would need to do 27 sweeps of 24 mm to cover the whole specimen. With a turn around time of 1 sec at the end of each row, the system is capable of completing a sweep in 3 seconds and completing the full coverslip scan in 81 seconds or 1.35 minutes. The degree to which images are perceived to be out of focus increases with magnification. Using the automated microscopy system of FIG. 4, we have achieved good focus with magnifications in the range of 4× to 10×; in some instances, we have achieved focus of a quality sufficient to provide usable information at 20×.

Although an automated cytometry system have been described with reference to representative embodiments, it should be understood that various modifications can be made without departing from the spirit of the invention. Accordingly, the protection to be accorded to the automated cytometry system and method is limited only by the following claims.

1. An automated microscopy system, comprising:
a continuous-scanning image acquisition unit comprising one or more time-delay-and-integrate cameras for operating synchronously in time and direction to acquire an image of a microscope specimen moving at a constant velocity, when the microscope specimen is moved by a scanning unit; and,
a reflective positioning unit to automatically focus the automated microscopy system during scanning, the reflective positioning unit comprising a laser for creating a spot of light reflected from a surface, a layer, or a lamina of a specimen holder that supports the specimen, a mechanism for sensing displacement of the spot of light, a mechanism for calculating a displacement in axial position of the specimen holder based on the displacement of the soot of light, and a mechanism for adjusting focus of the microscopy system in response to the displacement in an axial position of the specimen holder to keep the image of the specimen being acquired in focus during scanning.

2-4. (canceled)

5. The automated microscopy system of claim 1 in which the continuous-scanning image acquisition unit acquires images at a magnification of 10×.

6. A method of operating an automated microscopy system according to claim 1, comprising:
acquiring images of a specimen by a continuous-scanning method; and,
automatically focusing the automated microscopy system during scanning by a reflective positioning method.

7. The method of claim 6 in which acquiring images of a specimen includes time-delay-and-integration image acquisition.

8. The method of claim 6 in which automatically focusing the automated microscopy system includes automatically focusing in response to reflection of an optical image from a surface or a layer of an object on which a specimen imaged by the continuous-scanning image acquisition unit is mounted.

9. The method of claim 8 in which acquiring images of a specimen includes time-delay-and-integration image acquisition.

10. The method of claim 6 in which acquiring images includes acquiring images at a magnification of 10×.
